(19) United States
(12) Patent Application Publication
(10) Pub. No.: US 2010/0186979 A1
(43) Pub. Date: Jul. 29, 2010

(54) MACHINE HAND TOOL HOUSING UNIT

(76) Inventors: Jochen Krauter, Hildrizhausen (DE); Bernhard Hegemann, Filderstadt (DE); Thomas Bernhardt, Aichtal-Groetzingen (DE); Andreas Schlegel, Leinfelden-Echterdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/664,930

(22) PCT Filed: Apr. 21, 2008
(86) PCT No.: PCT/EP2008/054802

§ 371 Date: Dec. 16, 2009

(30) Foreign Application Priority Data
Jun. 20, 2007 (DE) 10 2007 028 382.4

(51) Int. Cl. B25F 5/02

(52) U.S. Cl. 173/162.2; 29/527.1

(57) ABSTRACT

The invention relates particularly to a hand-held power tool housing unit which surrounds at least one component of the hand-hand power tool, having a first housing part, a second housing part, and a damping device disposed between the two housing parts. It is proposed that the damping device forms an additional housing part.

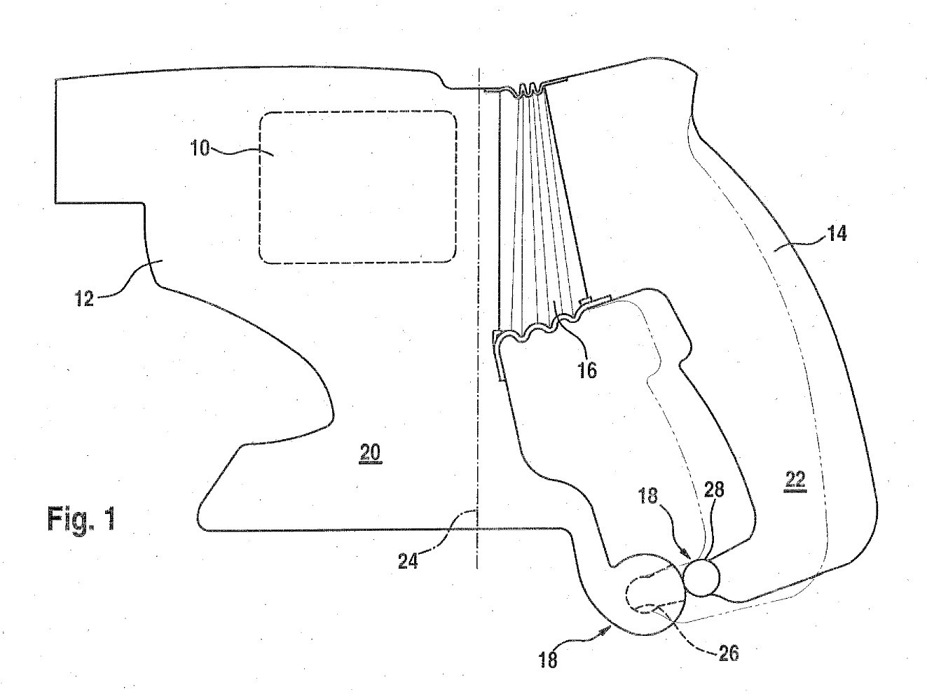

### PRIOR ART

The invention is based in particular on a hand-held power tool with a hand-held power tool housing unit according to the preamble to claim 1.

DE 100 66 115 A1 has disclosed a hand-held power tool with a hand-held power tool housing unit, which encloses all components of the hand-held power tool. The housing unit includes a first housing part embodied as a machine housing and a second housing part embodied as a handle. In addition, the hand-held power tool has a second handle that is embodied particularly for guiding and holding oscillating devices in that the handle is equipped with an oscillation-damping device. To this end, the handle has a grip element into which the damping device is integrated.

### ADVANTAGES OF THE INVENTION

The invention is based in particular on a hand-held power tool housing unit, which encompasses at least one component of the hand-held power tool, with a first housing part, a second housing part, and a damping device.

According to one proposal, the damping device forms another housing part. The term “damping device” should be understood in particular to mean a device for damping oscillations, vibrations, jolts, and/or impacts. According to the embodiment, the damping device is integrated into the housing unit in a space-saving fashion that also reduces the number of required parts. This makes it possible to eliminate the use of additional elements for a damping device and fastening means for the additional elements. It is therefore possible to manufacture a hand-held power tool housing unit of various materials with different properties and functions, without using additional elements.

In addition to the housings of hand-held power tools, in particular hand-held electric power tools, the hand-held power tool housing units can also include attachments for hand-held power tools, e.g. chargers, or their housings. The hand-held power tools can in particular be rotary hammers, chisel hammers, drills, grinders, drivers, saws, routers, planes, etc.

The damping device embodied as the housing part is advantageously situated between the first housing part and the second housing part. This embodiment makes it possible, in a structurally simple and inexpensive way, to at least reduce a transmission of oscillations, vibrations, and/or impacts from the first housing part to the second housing part and makes it possible to integrate the damping device into the housing unit. The damping device also compensates for movements that may possibly occur between the first and second housing part.

The damping device is advantageously connected to the machine housing and the at least one handle in an integrally joined fashion. The expression “integrally joined connections” should be understood here to mean all connections in which the connection partners are held together by atomic or molecular forces. At the same time, these include non-detachable connections such as soldering, welding, gluing, vulcanization, pressing, etc. that can only be detached by destroying the connecting means. This secure connection makes it possible to avoid a detachment for example of the handle from the machine housing and makes it possible to maintain constant control of the hand-held power tool via the handle. Furthermore, an integrally joined connection makes it possible to achieve a particularly simple, inexpensive manufacture without using additional fastening means.

According to one proposed embodiment variant, the damping device is connected to the first housing part and the second housing part in an integrally joined fashion by means of an injection-molding process. This makes it possible to simply and inexpensively manufacture a hand-held power tool housing unit that is preferably composed of several materials. In this case, the housing parts can be fastened without additional fastening elements since the housing parts are already attached to each other securely and durably, solely by means of the injection-molding process.

In another embodiment, the hand-held power tool housing unit has a hinge joint via which the first housing part is connected to the second housing part. This hinge joint permits a hinging action between the first housing part and the second housing part and consequently also serves to compensate for movement between the first and second housing parts.

The damping device is advantageously embodied in the form of a bellows. The term “bellows” should be understood here to mean an elastic tube that folds in an “accordion-like” fashion and which, for damping reasons, is mounted between the first housing part and the second housing part. The embodiment of the damping device as movable thanks to the bellows makes it possible to reduce or damp the transmission of oscillations from the first housing part to the second housing part during normal operation of the hand-held power tool. Additionally, in the event of a tilting motion between the first and second housing parts, the bellows-like construction of the damping device makes it possible to avoid the occurrence of undesirable tensile stresses and an accompanying transmission of oscillations in the damping device. An overexpansion of the damping device is avoided thanks to the bellows-like design, making it possible to extend the service life of the hand-held power tool.

An advantageously rugged and simple design and a consequently simplified assembly of the hand-held power tool can be achieved if the first housing part and/or the second housing part is/are respectively composed of two shells. After being manufactured, the shells can be filled with components and connected to each other once filled.

Another advantageous reduction in assembly complexity can be achieved in that the damping device is composed of at least two parts.

According to one proposal, the damping device has elastically deformable bending beams for the damping. The energy to be damped is then spent on the work of bending the bending beams. Moreover, the damping device is thus elastically accommodated inside the housing unit. Oscillations, vibrations, and/or impacts are thus transmitted from the machine housing to the handle at only a damped or reduced intensity.

According to another proposal, the first housing is embodied as a machine housing and the second housing is embodied as a handle. This makes it possible in a structurally simple, inexpensive fashion to reduce or damp the transmission of oscillations, vibrations, and/or impacts from the machine housing to the handle. Furthermore, in addition to the damping and to a resulting comfortable guidance of the hand-held power tool, this also makes it possible to reduce noise during operation of the hand-held power tool. The hand-held power tool is quiet and comfortable to guide.

### DRAWING

Other advantages ensue from the following description of the drawings. The drawing show an exemplary embodiment of the invention. The drawings, the description, and the claims contain numerous features in combination. Those skilled in the art will also suitably consider the features individually and unite them in other meaningful combinations.

### DESCRIPTION OF THE EXEMPLARY EMBODIMENTS

The sole FIGURE shows a simplified depiction of a hand-held power tool according to the invention, with a hand-held power tool housing unit. The housing unit can encompass one more components of the hand-held power tool. For example, the components can be the machine part of the hand-held power tool, in particular equipped with an electric motor, a fan unit, a transmission unit, etc.; a battery pack of the hand-held power tool; a charger for the battery pack of the hand-held power tool, etc. However, it is just as possible for the housing unit to completely encompass all components of the hand-held power tool apart from necessary openings and passages. In the present exemplary embodiment, an electric motor 10 is shown as a representative example for other components and is encompassed by the housing unit of the hand-held power tool. The hand-held power tool housing unit includes a first housing part 12, a second housing part 14, and a damping device 16. In the present exemplary embodiment, the first housing part is embodied as a machine housing 12 and the second housing part is embodied as a handle 14.

According to the invention, the damping device 16 constitutes an additional housing part of the hand-held power tool unit. In the present exemplary embodiment, the hand-held power tool unit is composed of three housing parts 12, 14, and 16 encompassing the components 10; it is conceivable for it to have any number of housing parts deemed suitable by those skilled in the art. The damping device 16 is advantageously situated between the first housing part 12 embodied as a machine housing and the second housing part 14 embodied as a handle, with the machine housing 12 at least partially connected to the handle 14 via the damping device 16.

In the present exemplary embodiment, the damping device 16 is connected to the first housing part 12 and second housing part 14 in an integrally joined fashion. Preferably, the housing parts 12, 14, 16 are integrally joined by means of an injection-molding process. During the injection-molding, the damping device 16 is integrally formed onto the housing part 14 embodied as the handle and onto the housing part 12 embodied as the machine housing.

The first housing part 12 and second housing part 14 are also connected to each other by means of a hinge joint 18; in the drawing, the hinge joint 18 is not assembled. The hinge joint 18 is essentially situated below the damping device 16 in the direction of a vertical axis 24 of the hand-held power tool. The hinge joint 18 is integrated into the two housing parts 12, 14 or formed onto the housing parts 12, 14 in that the first housing part 12 has a recess 26 and the second housing part 14 has a projection 28 that can be clipped into the recess 26 of the first housing part 12. The hinge joint 18, in connection with the damping device 16, permits a relative motion or rotating motion of the machine housing 12 in relation to the handle 14.

The first housing part 12 and the second housing part 14 are preferably comprised of a dimensionally stable material, in particular a dimensionally stable plastic. A housing unit composed of different housing parts usually performs several functions. The machine housing 12, for example, serves to protect the components contained in it and is therefore most often made of a dimensionally stable material; in particular, the dimensionally stable material has shock-resistant and impact-resistant properties. The handle 14 is used to guide and hold the usually oscillating hand-held power tool and is therefore likewise preferably made of a dimensionally stable material that preferably also has shock-resistant and impact-resistant properties. The damping device 16 has elastically deformable bending beams for the damping. In the present exemplary embodiment, the damping device 16 is embodied in the form of a bellows and is preferably composed of an elastic material. In any case, the material for the damping device 16 must be more elastic than the material for the two housing parts 12, 14.

In order to facilitate manufacture, the first housing part 12 and the second housing part 14 in this exemplary embodiment are each composed of a respective pair of half shells 20, 22. The damping device 16 is also composed of two parts. In the manufacture of the hand-held power tool, two respective halves or half shells of a hand-held power tool housing unit—which are situated opposite each other and correspond to each other—are produced, equipped with the required components of the hand-held power tool, and then connected to each other.

The damping device 16 embodied in the form of another housing part is injection-molded onto the first housing part 12 and second housing part 14 in that the damping device 16 is injection-molded onto two respective half shells 20, 22 on the same side of the two pairs of half shells.

The manufacture of the hand-held power tool housing unit occurs in several steps. First, the two half shells 20, 22 on the same side of the machine housing 12 and handle 14 are inserted into a mold, with the half shells 20, 22 spaced apart from each other in order to form an intermediate space in the mold. Then the mold is closed. The molding compound is then injected into the intermediate space, forming the damping device 16 and simultaneously forming a connection between the two half shells 20, 22. In other words, the half of the damping device 16 is injection-molded and formed onto the half of the housing part 14 embodied as the handle and onto the half of the housing part 12 embodied as the machine housing. Then the mold is opened and the connected halves of the housing parts 12, 14, 16 or the half of the housing unit are/is removed, with the half of the bellows of the damping device 16 being essentially stretched taut. This half of the housing unit is then equipped with the necessary components 10 of the hand-held power tool and then connected to the associated second half of the housing unit in that the hinge joint 18 is assembled by clipping the projection 28 of the second housing part 14 into the recess 26 of the first housing part 12 and the two halves of the housing unit are connected to each other, for example by means of screws. This compresses the bellows of the damping device 16.

1-14. (canceled)

15. A hand-held power tool housing unit which encompasses at least one component of a hand-held power tool, comprising:
a first housing part;
a second housing part; and
a damping device, wherein the damping device constitutes an additional housing part.

16. The hand-held power tool housing unit as recited in claim 15, wherein the damping device is situated between the first housing part and the second housing part.

17. The hand-held power tool housing unit as recited in claim 15, wherein the damping device is connected to the first housing part and/or the second housing part in an integrally joined fashion.

18. The hand-held power tool housing unit as recited in claim 16, wherein the damping device is connected to the first housing part and/or the second housing part in an integrally joined fashion.

19. The hand-held power tool housing unit as recited in claim 17, wherein the damping device is connected to the first housing part and/or the second housing part in an integrally joined fashion by means of an injection-molding process.

20. The hand-held power tool housing unit as recited in claim 16, further comprising a hinge joint via which the first housing part is connected to the second housing part.

21. The hand-held power tool housing unit as recited in claim 17, further comprising a hinge joint via which the first housing part is connected to the second housing part.

22. The hand-held power tool housing unit as recited in claim 18, further comprising a hinge joint via which the first housing part is connected to the second housing part.

23. The hand-held power tool housing unit as recited in claim 16, wherein the damping device is embodied in the form of a bellows.

24. The hand-held power tool housing unit as recited in claim 17, wherein the damping device is embodied in the form of a bellows.

25. The hand-held power tool housing unit as recited in claim 18, wherein the damping device is embodied in the form of a bellows.

26. The hand-held power tool housing unit as recited in claim 19, wherein the damping device is embodied in the form of a bellows.

27. The hand-held power tool housing unit as recited in claim 16, wherein the first housing part and/or the second housing part has/each have at least two respective shells.

28. The hand-held power tool housing unit as recited in claim 16, wherein the damping device is composed of at least two parts.

29. The hand-held power tool housing unit as recited in claim 16, wherein the damping device has elastically deformable bending beams for the damping.

30. The hand-held power tool housing unit as recited in claim 16, wherein the first housing part is embodied as a machine housing.

31. The hand-held power tool housing unit as recited in claim 16, wherein the second housing part is embodied as a handle.

32. A hand-held power tool with a hand-held power tool housing unit as recited in claim 15.

33. A method for manufacturing a hand-held power tool housing unit, having a first housing part, a second housing part, and a damping device embodied in the form of an additional housing part, the method comprising the step of injection-molding the damping device onto the first housing part and/or the second housing part.

34. The method as recited in claim 33, wherein the first housing part has a first pair of half shells, the second housing part has a second pair of half shells, and the damping device is injection-molded onto one respective half shells of the first pair and the second pair on a same side of the first pair and the second pair of half shells.
